(19) United States
(12) Patent Application Publication
(10) Pub. No.: US 2005/0270597 A1
(43) Pub. Date: Dec. 8, 2005

(54) Image processing system for an image capturing device

(76) Inventors: Chin-Yuan Lin, Taichung (TW); Chia-Chan Chang, Kaohsiung City (TW); Chien-Hung Chen, Hsinchu City (TW)

Correspondence Address: RABIN & Berdo, PC, 1101 14TH STREET, NW, SUITE 500, WASHINGTON, DC, 20005, US

(21) Appl. No.: 11/144,938

(22) Filed: Jun. 6, 2005

(30) Foreign Application Priority Data
Jun. 7, 2004 (TW) 93116358

(51) Int. Cl. H04N 1/56

(52) U.S. Cl. 358/515

(57) ABSTRACT

An image processing system of a scanner including an optical sensing unit, several analog signal processing units, a control processing unit, a memory unit and an image registration unit. The optical sensing unit captures an image of document, and several analog monochromatic image signals are generated and transmitted accordingly. The analog signal processing units correspondingly receives the analog monochromatic image signals and several digital monochromatic image signals are generated and transmitted accordingly. The control processing unit processes the digital monochromatic image signal and several processed monochromatic image data are generated and transmitted accordingly. The memory unit receives and stores the processed monochromatic image data. The image registration unit retrieves the processed monochromatic image data stored in the memory unit and a color image is produced accordingly.

This application claims the benefit of Taiwan application Serial No. 93116358, filed Jun. 7, 2004, the subject matter of which is incorporated herein by reference.

### BACKGROUND OF THE INVENTION

1. Field of the Invention

The invention relates to an image processing system for an image capturing device, and more particularly to an image processing system for a scanning device, which is able to accelerate the processing of color images.

2. Description of the Related Art

With the progression of the science and the technology, the integration and application of multi-media have become a trend of modern living. Multi-media refer to various data types including texts, images, and sound etc. In order to present data in the form of multi-media, various multi-media devices, which are able to capture image or sound, have been developed. As for the image processing, a color scanner or a scanning device installed in a multifunction peripheral or a digital copier are devices often used as the image capturing tool.

FIG. 1 is the block diagram of a conventional color scanner coupled with the computer. The image processing system 10 of the scanner includes a red (R) charge coupled device (CCD) 11a, a green (G) CCD 11b, a blue (B) CCD, an analog front end (AFE) processor 12, a application specific integrated circuit (ASIC) 13, and a random access memory (RAM) 14. The (R) CCD 11a, (G) CCD 11b and the (B) CCD 11c capture the image of the document and an analog (R) image signal Ra, an analog (G) image signal Ga, and an analog (B) image signal Ba can be generated and transmitted accordingly. The AFE 12 in turn receives analog (R) image signal Ra, analog (G) image signal Ga, and analog (B) image signal Ba. And successively a digital (R) image signal Rd1, a digital (G) image signal Gd1 and a digital (B) image signal Bd1 are generated and transmitted accordingly. The ASIC 13 is used in turn to receive digital (R) image signal Rd1, a digital (G) image signal Gd1 and a digital (B) image signal Bd1. After the digital (R) image signal Rd1, digital (G) image signal Gd1 and digital (B) image signal Bd1 are processed by ASCI, a color image (CI) corresponding to the document is produced accordingly. In addition, The RAM 14 receives and stores the CI. Afterward, users can retrieve CI from the RAM 14 with the aid of the computer 15 so as to carry out actions such as displaying, identifying, editing, storage, and outputting the CI.

When the scanner functions in the gray mode to scan the document, the time required for the ASIC 13 and the AFE processor 12 of the image processing system 10 of the scanner to process data is approximately T. While the scanner functions in the color mode to scan the same document, the ASIC 13 and the AFE processor 12 of the image processing system 10 function as a single array. The ASIC 13 and the AFE processor 12 can only receive and process one of the analog (R) image signal Ra, an analog (G) image signal Ga, and an analog (B) image signal Ba each time. Thus, the time required for the ASIC 13 and AFE processor 12 to process the analog (R) image signal Ra, an analog (G) image signal Ga, and an analog (B) image signal Ba is approximately 3T. Therefore, in the conventional image processing structure, a long period of time is required for the image processing system 10 of a conventional scanner to process color images.

### SUMMARY OF THE INVENTION

It is therefore an object of the invention to provide an image processing system of an image capturing device, in which a plurality of analog signal processing units correspondingly receives and process a plurality of analog monochromatic image signals to accelerate processing speed and reduce time required for the image capturing device to process color image. Hence the practicality of the image capturing device is greatly improved.

It is an object of the present invention to provide an image processing system of the image capturing device including an optical sensing unit, a plurality of analog signal processing units, a plurality of control processing units, a plurality of memory units, and an image registration unit. The optical sensing unit captures an image of a document and a plurality of the analog monochromatic image signals is generated and transmitted accordingly. These analog signal processing units correspondingly receive these analog monochromatic image signals and a plurality of digital monochromatic image signals is generated and transmitted accordingly. The control processing units correspondingly process the digital monochromatic image signals and a plurality of processed monochromatic image data is generated and transmitted accordingly. The memory units correspondingly receive and store the processed monochromatic image data. The image registration unit retrieves the processed monochromatic image data from the memory units and a color image (CI) is produced accordingly.

It is another object of the present invention to provide an image processing system of an image capturing device including an optical sensing unit, a first analog signal processing unit, a second analog signal processing unit, a processor, a memory and an image registration unit. The optical sensing unit captures an image of a document, and a first analog monochromatic image signal, a second analog monochromatic image signal and a third analog monochromatic image signal are generated and transmitted accordingly. The first analog signal processing unit receives the first analog monochromatic image signal and the second analog monochromatic image signal, and a first digital monochromatic image signal and a second digital monochromatic image signal are generated and transmitted accordingly. The second analog signal processing unit receives the third analog monochromatic image signal and a third digital monochromatic image signal is generated and transmitted. The processor processes the first digital monochromatic image signal, the second digital monochromatic image signal and the third digital monochromatic image signal, and a first processed monochromatic image data, a second processed monochromatic image data and a third processed monochromatic image data are generated and transmitted. The memory receives and stores the first processed monochromatic image data, the second processed monochromatic image data and the third processed monochromatic image data. The image registration unit retrieves the first processed monochromatic image data, the second processed monochromatic image data and the third processed monochromatic image data stored in the memory, and a color image (CI) is produced accordingly.

It is another objective of the invention to provide an image processing system of an image capturing device including an optical sensing unit, a first analog signal processing unit, a second analog signal processing unit and a control processing unit. The optical sensing unit captures an image of a document and a first analog monochromatic image signal, a second analog monochromatic image signal and a third analog monochromatic image signal are generated and transmitted accordingly. The first analog signal processing unit receives the first analog monochromatic image signal and the second analog monochromatic image signal, and a first digital monochromatic image signal and a second digital monochromatic image signal are generated and transmitted accordingly. The second analog signal processing unit receives the third analog monochromatic image signal and a third digital monochromatic image signal is generated and transmitted accordingly. The control processing unit processes the first digital monochromatic image signal, the second digital monochromatic image signal and the third digital monochromatic image signal, and a color image (CI) is produced accordingly.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is circuit block diagram of the color scanner coupled with a computer.

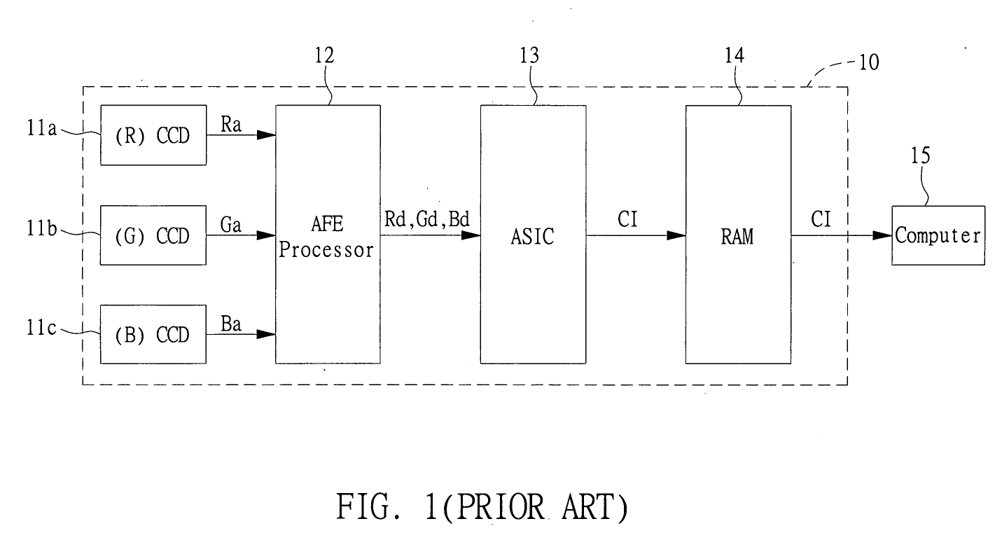

FIG. 2 is a circuit block diagram of the image processing system of the image capturing device coupled with the electronic device according to the first embodiment of the invention.

FIG. 3 is a circuit block diagram of the image processing system of the image capturing device coupled with the electronic device according to the second embodiment of the invention.

FIG. 4 shows a circuit block diagram of the image processing system of the image capturing device coupled with the electronic device according to the third embodiment of the invention.

FIG. 5 show a circuit block diagram of the image processing system of the image capturing device coupled with the electronic device according to the fourth embodiment of the invention.

### DETAILED DESCRIPTION OF THE INVENTION

### Embodiment I

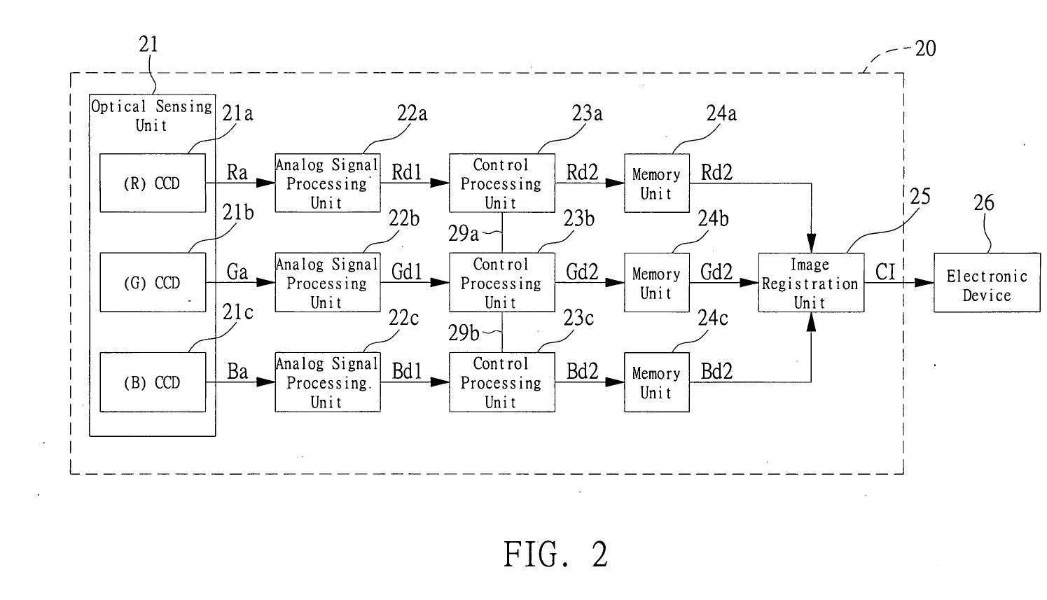

Referring to FIG. 2, the image processing system 20 of the image capturing device includes an optical sensing unit 21, a plurality of analog signal processing units 22a, 22b and 22c, a processor having a plurality of control processing units 23a, 23b and 23c, a memory having a plurality of memory units 24a, 24b and 24c and an image registration unit 25. The optical sensing unit 21 captures an image of a document and a plurality of analog monochromatic image signals are generated and transmitted accordingly. According to this embodiment of the present invention, the optical sensing unit 21 at least includes a red (R) charge coupled device (CCD) 21a, a green (G) CCD 21b and a blue (B) CCD 21c. The (R) CCD 21a, (G) CCD 21b, and (B) CCD 21c capture the image of the document and accordingly an analog (R) image signal Ra, an analog (G) image signal Ga and an analog (B) image signal Ba are generated and transmitted respectively. In addition, the optical sensing unit 21 also includes other types of optical sensor, such as contact image sensor.

The analog signal processing units correspondingly receive the analog monochromatic image signals, and a plurality of digital monochromatic image signals are generated and transmitted accordingly. In order to accelerate the image processing speed of the image processing system 20 of the image capturing device, the analog signal processing units 22a, 22b and 22c correspondingly receive the Ra, Ga and Ba, respectively. And then a digital red image signal Rd1, a digital green image signal Gd1, and a digital blue image signal Bd1 are correspondingly generated and transmitted accordingly.

The control processing units process the digital monochromatic image signals, such as the processing of image correction, compensation, and amplification of the digital monochromatic image signal. And then a plurality of processed monochromatic image data is generated and transmitted accordingly. In the present embodiment of the invention, the control processing units 23a, 23b and 23c correspondingly process the Rd1, Gd1 and Bd1, and a processed red image data Rd2, a processed green image data Gd2 and a processed blue image data Bd2 are generated and transmitted accordingly.

The memory units correspondingly receive and store the processed monochromatic image data. The three memory units 24a, 24b and 24c receive and store the processed Rd2, Gd2 and Bd2 according to the embodiment of the present invention. The image registration unit 25 captures the processed monochromatic image data stored in the memory units 24a, 24b and 24c, and a color image (CI) corresponding to the document is produced and displayed on the electronic device 26. Therefore, the electronic device 26 can displays, edits, identifies, saves, and outputs the CI. Furthermore, examples of the electronic device 26 are desktops, notebooks, laptops, handheld computers and personal digital assistants, mobile phones, flash disks, facsimiles, printers and the image outputting machines of any network node. In this embodiment of the present invention, the image registration unit 25 retrieves the Rd2 stored in the memory unit 24a, the Gd2 stored in the memory unit 24b and the Bd2 stored in the memory unit 24c, and the CI is produced and displayed on the electronic device 26.

When the scanner functions in the gray mode to scan the document, the total time required for the control processing units 23a˜23c and the corresponding analog signal processing unit 22a˜22c of the image processing system 20 of the image capturing device to complete processing the image data of the document is T. When the scanner functions in the color mode to scan the same document, the control processing units 23a˜23c and the corresponding analog signal processing units 22a˜22c of the image processing system 20 of the image capturing device proceed to process each color image signal independently and simultaneously. So the total time required for the control processing units 23a˜23c and corresponding analog signal processing units 22a˜22c is also approximately T.

While the invention has been described by way of example and in terms of an embodiment, it is to be understood that the invention is not limited thereto. For example, the analog signal processing units 22a, 22b and 22c are three analog front end (AFE) processors. The memory units 24a, 24b and 24c are the random access memory (RAM). The control processing units 23a, 23b and 23c are the application specific integrated circuit (ASIC) or microprocessor. Moreover, the control processing units 23a, 23b and 23c can also be integrated into one control processing unit, in which the control processing units 23a, 23b and 23c can be ASIC or microprocessor. In addition, the memory units 24a, 24b and 24c can be integrated into one memory unit as well and the memory units 24a, 24b and 24c can be RAM.

One of the control processing units 23a˜23c receives the scanning command and produces a scanning control signal and a motor control signal. The motor control signal controls the movement of the optical sensing unit 21 and the scanning control signal controls the scanning process of the optical sensing unit 21. In FIG. 2, the control processing units 23a˜23c are linked by the signal lines 29a and 29b, such that any one of the control processing units 23a˜23c can receive the scanning command. One of the control processing units 23a˜23c consequently produces the motor control signal, and another control processing unit of the control processing units 23a˜23c produces the scanning control signal.

### Embodiment II

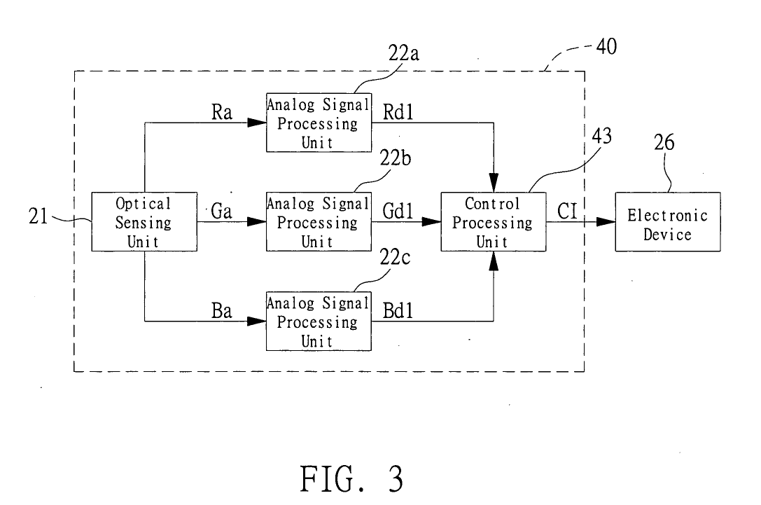

Refer to FIG. 3, which is the block diagram of the image processing system of the image capturing device coupled with an electronic device according to the second embodiment of the present invention. The difference between the image processing system 40 of the image capturing device of the second embodiment and the image processing system 20 of the image capturing device of the first embodiment is that the control processing unit 43 possesses the image registration function. Therefore, the image processing system 40 of the image capturing device is not designed with the memory units 24a˜24c and the image registration unit 25 shown in the FIG. 2. The similarity between the first embodiment and the second embodiment such as a similar numbering system will not be repeated. In FIG. 3, the control processing unit 43 processes digital image signal Rd1, Gd1 and Bd1, and a processed red image data, a processed green image data and a processed blue image data are correspondingly produced accordingly. The control processing unit 43 further transforms the processed red image data, processed green image data and processed blue image data and accordingly produces the color image CI. The control processing unit 43 then outputs the CI to the electronic device 26.

### Embodiment III

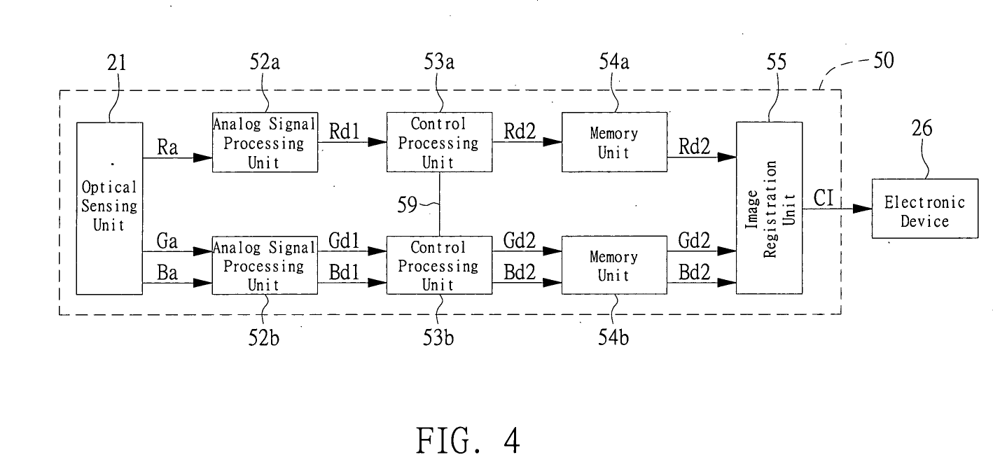

Referring to FIG. 4, the image processing system 50 of the image capturing device includes an optical sensing unit 21, two analog signal processing units 52a and 52b, two control processing units 53a and 53b, two memory units 54a and 54b, and an image registration unit 55. The optical sensing unit 21 captures an image of a document and three analog monochromatic image signals are generated and transmitted accordingly. The optical sensing unit 21 is illustrated in the first embodiment and will not be mentioned again. The analog signal processing unit 52a receives an analog monochromatic image signal and a digital monochromatic image signal is generated and transmitted accordingly. The analog signal processing unit 52b receives another two analog monochromatic image signals and another two digital monochromatic image signals can be generated and transmitted accordingly. In this embodiment of the present invention, analog signal processing unit 52a receives the analog red image signal Ra, and accordingly output a digital red image signal Rd1. The analog signal processing unit 52b receives the analog green image signal Ga and the analog blue image signal Ba, and a digital green image signal Gd1 and a digital blue image signal Bd1 are generated and transmitted accordingly.

The control processing unit 53a processes the digital red image signal Rd1 and a processed red image data Rd2 is generated and transmitted accordingly. The control processing unit 53b processes the digital green image signal Gd1 and the digital blue image signal Bd1 and a processed green image data Gd2 and a processed blue image data Bd2 are generated and transmitted accordingly. The memory unit 54a receives and stores the processed red image data Rd2, and the memory unit 54b receives and stores the processed Gd2 and the processed Bd2. The image registration unit 55 retrieves the processed Rd2, the processed Gd2 and the processed Bd2 stored in the memory unit 54a and the memory unit 54b respectively. Accordingly, the CI is produced and output to the electronic device 26.

While the invention has been described by way of example and in terms of an embodiment, it is to be understood that the invention is not limited thereto. For example, the analog signal processing units 52a and 52b are two analog front end (AFE) processors. The memory units 54a and 54b are random access memories. The control processing units 53a and 53b are two ASIC or microprocessors. Moreover, the control processing units 53a and 53b can be integrated into one control processing unit. The memory units 54a and 54b can also be integrated into one memory unit.

The control processing unit 53a and 53b receives a scanning command for producing a scanning control signal and a motor control signal. The motor control signal controls the movement of the optical sensing unit 21 and the scanning control signal controls the scanning process of the optical sensing unit 21. In FIG. 4, the control processing units 53a and 53b are linked by the signal line 59, such that any one of the control processing units 53a and 53b can receive a scanning command. And one of the control processing units 53a and 53b can produce the motor control signal, and the other of the control processing units 53a and 53b can produce the scanning control signal.

### Embodiment IV

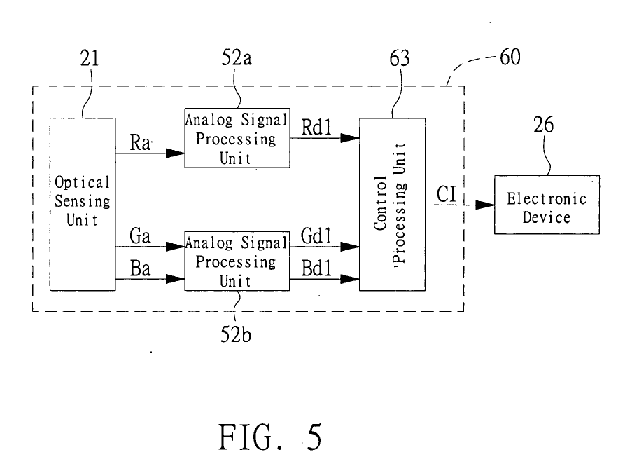

Refer to FIG. 5, which is a circuit block diagram illustrating the status of the image processing system of the image capturing device coupled with an electronic device according to the fourth embodiment of the invention. The difference between the image processing system 60 of the image capturing device of this embodiment and the image processing system 50 of the image capturing device of the third embodiment is that the control processing unit 63 possesses the image registration function. Therefore, the image processing system 60 of the image capturing device is not designed with the memory units 54a and 54b shown in FIG. 4 nor the image registration unit 55. In FIG. 5, the control processing unit 63 is used for processing the digital red image signal Rd1, the digital green image signal Gd1 and the digital blue image signal Bd1, such that a processed red image data, a processed green image data and a processed blue image data are generated accordingly. The control processing unit 63 then transforms the processed red image data, the processed green image data and the processed blue image data into a color image CI and outputs the color image CI to the electronic device 26.

A plurality of analog monochromatic image signals can be correspondingly received by a plurality of analog signal processing units according to the embodiment of the present. This embodiment of the invention can accelerate the speed for processing CI and comparatively reduce time required for the image capturing device to process a CI.

While the invention has been described by way of examples and in terms of an embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An image processing system for an image capturing device, comprising:
an optical sensing unit for capturing an image of a document and outputting a plurality of analog monochromatic image signals accordingly;
a plurality of analog signal processing units for correspondingly receiving the analog monochromatic image signals and outputting a plurality of digital monochromatic image signals accordingly;
a processor for processing the digital monochromatic image signals and outputting a plurality of processed monochromatic image data accordingly;
a memory for receiving and storing the processed monochromatic image data; and
an image registration unit for retrieving the processed monochromatic image data stored in the memory and producing a color image (CI) accordingly.

2. The image processing system according to claim 1, wherein the analog signal processing units are a plurality of analog front end (AFE) processors.

3. The image processing system according to claim 1, wherein the processor is an application specific integrated circuit (ASIC).

4. The image processing system according to claim 1, wherein the memory is a random access memory (RAM).

5. The image processing system according to claim 1, wherein the optical sensing unit comprises a red charge coupled device (CCD), a green CCD and a blue CCD.

6. The image processing system according to claim 5, wherein the analog monochromatic image signals comprises an analog red image signal output by the red CCD, an analog green image signal output by the green CCD and an analog blue image signal output by the blue CCD.

7. The image processing system according to claim 1, wherein the processor comprises:
a plurality of control processing units for processing the digital monochromatic image signals and outputting the processed monochromatic image data to the memory.

8. The image processing system according to claim 7, wherein the control processing units are a plurality of application specific integrated circuit (ASIC).

9. The image processing system according to claim 7, wherein the memory comprises:
a plurality of memory units for correspondingly receiving and storing the processed monochromatic image data.

10. The image processing system according to claim 9, wherein the memory units are a plurality of random access memory (RAM).

11. The image processing system according to claim 7, wherein the control processing units communicate thereamong synchronously through a plurality of signal lines.

12. An image processing system for an image capturing device, comprising:
an optical sensing unit for capturing an image of a document and outputting a plurality of analog monochromatic image signals accordingly;
a plurality of analog signal processing units for receiving the analog monochromatic image signals and outputting a plurality of digital monochromatic image signals; and
a control processing unit for processing the digital monochromatic image signal and producing a color image (CI) accordingly.

13. The image processing system according to claim 12, wherein the analog signal processing units are a plurality of analog front end (AFE) processors.

14. The image processing system according to claim 12, wherein the analog signal processing units receive the analog monochromatic image signals and output the corresponding digital monochromatic image signals to the control processing unit.

15. The image processing system according to claim 12, wherein the control processing unit is an application specific integrated circuit (ASIC).

16. The image processing system according to claim 12, wherein the optical sensing unit comprises a red CCD, a green CCD and a blue CCD.

17. The image processing system according to claim 16, wherein the analog monochromatic image signals comprise an analog red image signal output by the red CCD, a green image signal output by the green CCD, and a blue image signal output by the blue CCD.

18. An image processing system for an image capturing device comprising:
an optical sensing unit for capturing an image of a document and accordingly outputting a first analog monochromatic image signal, a second analog monochromatic image signal and a third analog monochromatic image signal;
a first analog signal processing unit for receiving the first analog monochromatic image signal and the second analog monochromatic image signal, and accordingly outputting a first digital monochromatic image signal and a second digital monochromatic image signal;
a second analog signal processing for receiving the third analog monochromatic image signal and accordingly outputting a third digital monochromatic image signal;
a processor for processing the first digital monochromatic image signal, the second digital monochromatic image signal and the third digital monochromatic image signal and outputting a first processed monochromatic image data, a second processed monochromatic image data and a third processed monochromatic image data accordingly;
a memory for receiving and storing the first processed monochromatic image data, the second processed monochromatic image data and the third processed monochromatic image data; and
an image registration unit for retrieving the first processed monochromatic image data, the second processed monochromatic image data and the third processed monochromatic image data stored in the memory and producing a color image (CI) accordingly.

19. The image processing system according to claim 18, wherein the optical sensing unit comprises a red charge coupled device (CCD), a green CCD, and a blue CCD.

20. The image processing system according to claim 19, wherein the first analog monochromatic image signal, the second analog monochromatic image signal, and the third analog monochromatic image signal are an analog red image signal output by the red CCD and an analog green image signal output by the green CCD and an analog blue image signal output by the blue CCD, respectively.

21. The image processing system according to claim 18, wherein the processor comprises:
a first control processing unit for processing the first digital monochromatic image signal and the second digital monochromatic image signal correspondingly and outputting the first processed monochromatic image data and the second processed monochromatic image data to the memory accordingly; and
a second control processing unit for processing the third digital monochromatic image signal and outputting the third processed monochromatic image data accordingly.

22. The image processing system according to claim 21, wherein the memory comprises:
a first memory unit for receiving and storing the first processed monochromatic image data and the second processed monochromatic image data correspondingly; and
a second memory unit for receiving and storing the third processed monochromatic image data correspondingly.

23. The image processing system according to claim 21, wherein the first control processing unit and the second control processing unit communicate therebetween synchronously through a signal line.

24. An image processing system for an image capturing device, comprising:
an optical sensing unit for capturing an image of a document and outputting a first analog monochromatic image signal, a second analog monochromatic image signal, and a third analog monochromatic image signal accordingly;
a first analog signal processing unit for receiving the first analog monochromatic image signal and the second analog monochromatic image signal, and outputting a first digital monochromatic image signal and a second digital monochromatic image signal accordingly;
a second analog signal processing unit for receiving the third analog monochromatic image signal, and outputting a third digital monochromatic image signal accordingly; and
a control processing unit for processing the first digital monochromatic image signal, the second digital monochromatic image signal and the third digital monochromatic image signal, and producing a color image (CI) accordingly.

25. The image processing system according to claim 24, wherein the optical unit comprises a red charge coupled device (CCD), a green charge coupled device (CCD) and a blue charge coupled device (CCD).

26. The image processing system according to claim 25, wherein the first analog monochromatic image signal, the second analog monochromatic image signal and the third analog monochromatic image signal are respectively an analog red image signal output by the red CCD, an analog green image signal output by the green CCD and an analog blue image signal output by the blue CCD.
